(19) United States
(12) Patent Application Publication
(10) Pub. No.: US 2008/0011277 A1
(43) Pub. Date: Jan. 17, 2008

(54) Interface weld seal for low permeation flange of a fuel supply unit

(75) Inventors: Parag Athalye, Auburn Hills, MI (US); John P. Wattai, Rochester Hills, MI (US); Stephane Seps, Detroit, MI (US); Matthias Nederegger, Rochester Hills, MI (US); Darren Matthew Berger, Goodrich, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/826,280

(22) Filed: Jul. 13, 2007

Related U.S. Application Data
(60) Provisional application No. 60/830,816, filed on Jul. 14, 2006.

(51) Int. Cl. F02M 37/04

(52) U.S. Cl. 123/509

(57) ABSTRACT

A flange structure (10′) for a fuel supply unit of a vehicle includes at least one electrically conductive fuel port (16′) having first and second ends (22, 24). A plastic flange (20′) is overmolded on at least a portion of the fuel port between the first and second ends. The flange is constructed and arranged to be coupled with a fuel tank of a vehicle. A welded connection (26) is provided between the fuel port and the plastic flange defining a barrier to prevent fuel or fuel vapor from passing between the periphery of the fuel port and the flange.

This application claims the benefit of the earlier filing date of U.S. Provisional Application No. 60/830,816, filed on Jul. 14, 2006, and claims the benefit thereof for priority purposes.

### FIELD OF THE INVENTION

The invention relates to fuel supply units for automobile vehicles and, more particularly, to providing a permeation barrier between a conductive fuel port and a non-conductive flange.

### BACKGROUND OF THE INVENTION

With reference to FIG. 1, a typical fuel supply unit for a vehicle includes flange structure, generally indicated at 10 including a steel or plastic flange 20 configured to be sealed to a wall of a fuel tank. The flange structure 10 is interconnected with a fuel pump assembly 12 by a pair of metal struts 14. The flange structure 10 also includes various ports 16 that provide pathways into and out of the tank for fuel. The ports 16 are connected with the fuel pump 12 to supply fuel to an engine, but the connecting tubes are not shown in FIG. 1.

Recently, there has been a greater focus on Electro Static Dissipation (ESD) in such fuel supply systems. It is known that as fuel flows through various components of the fuel supply system, such as the fuel pump assembly, the fuel filter, and various valving and tubing, there is the potential for static electricity to be generated in the various conductive components of the fuel supply system. To dissipate this static electricity, fuel supply systems electrically ground the components through electrical interconnection.

For example, as shown in FIG. 1, some systems employ a separate cable harness 18 which grounds through the pump negative. Other systems employ grounding clips (not shown) that touch an inline filter. In addition, conductive portions of fuel ports have been grounded.

There is a need provide for ESD of fuel ports while creating a barrier to prevent permeation or leakage of fuel around the fuel port.

### SUMMARY OF THE INVENTION

An object of the invention is to fulfill the need referred to above. In accordance with the principles of the present invention, this objective is obtained by providing a flange structure for a fuel supply unit of a vehicle. The flange structure includes at least one electrically conductive fuel port having a periphery and first and second ends. A plastic flange is overmolded on at least a portion of the periphery of the fuel port between the first and second ends. The flange is constructed and arranged to be coupled with a fuel tank of a vehicle. A welded connection is provided between the fuel port and the plastic flange defining a barrier to prevent fuel or fuel vapor from passing between the periphery of the fuel port and the flange.

In accordance with another aspect of the disclosed embodiment, a method of providing a flange structure for a fuel supply unit of a vehicle provides at least one electrically conductive fuel port having a periphery and first and second ends. A plastic flange is overmolded on at least a portion of the periphery of the fuel port between the first and second ends. The method includes welding a connection between the fuel port and the plastic flange to define a barrier to prevent fuel or fuel vapor from passing between the periphery of the fuel port and the flange.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a view of conventional fuel supply unit of a vehicle.

FIG. 2 is a sectional view of a flange structure including a flange and a fuel port provided in accordance with an embodiment of the invention.

### DETAILED DESCRIPTION OF THE EXEMPLARY EMBODIMENT

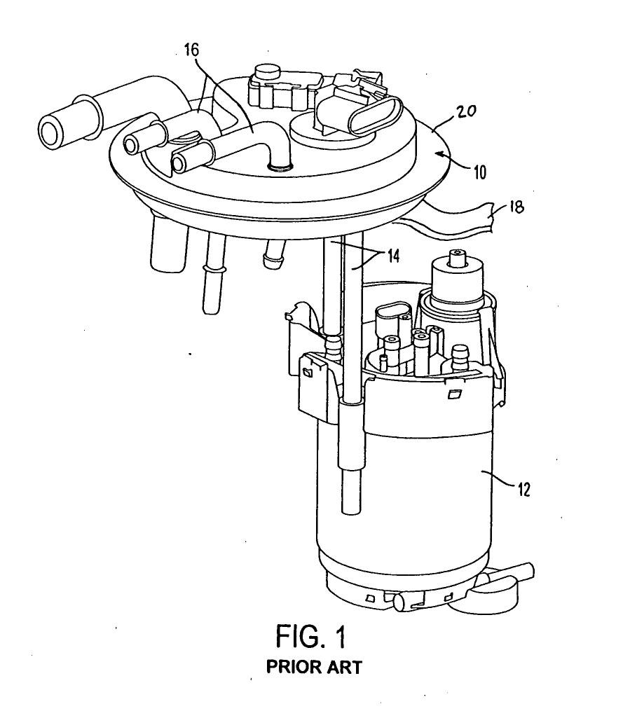

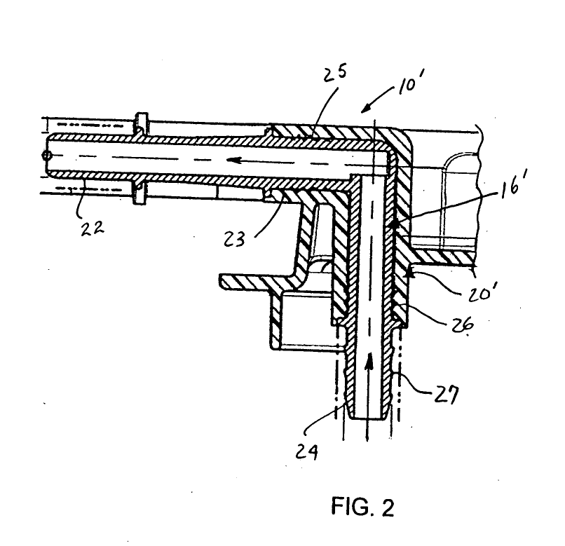

With reference to FIG. 2, a portion of a flange structure, generally indicated at 10′, is shown in accordance with the principles of an embodiment of the invention. The flange structure 10′ can be similar to the flange structure 10 shown in FIG. 1, employed in a fuel supply unit of a vehicle. The flange structure 10′ includes a fuel port, generally indicted at 16′ and a flange, generally indicated at 20′, overmolded on at least a portion of the fuel port 16′.

The fuel port 16′ is electrically conductive, preferably of insert molded plastic having a first end 22 and a second end 24. As noted above, a portion of the periphery 23 of the fuel port 16′ between the first and second ends is overmolded with a non-conductive plastic flange 20′. In the embodiment, the periphery 23 of the fuel port 16′ includes surface features such as scallops or wave-like features 25 that engage with the overmolded flange 20′ to ensure a good connection between the flange 20′ and fuel port 16′.

The flange 20′ is constructed and arranged to be sealed to a wall of a fuel tank (not shown). Thus, the first end 22 is accessible at an outside portion of the flange 20′ and is constructed and arranged to be connected at the engine side of a vehicle and grounded. The second end 24 of the fuel port 16′ is associated with the inside portion of the flange 20′ and thus is to be exposed to fuel in a fuel tank (not shown). The second end 24 of the fuel port 16′ preferably is a male end that includes barbs 27 so as to be coupled with tubing to a fuel pump (not shown in FIG. 2) preferably of the type shown in FIG. 1. Instead of grounding the fuel port 16′ on the engine side, alternatively, the second end 24 can be grounded at the fuel pump. In the embodiment fuel moves in the direction of the arrows in FIG. 2, from the pump to the engine of a vehicle.

Since the end 24 of the fuel port 16′ is exposed to fuel, there is a chance of leakage or permeation of fuel or fuel vapors between the periphery 23 of the fuel port 16′ and the overmolded flange 20′. Thus, in accordance with the embodiment, after overmolding the flange 20′, a laser welded connection 26 is provided between the fuel port 16′ and the flange 20. More particularly, a laser weld process is performed so that the material of the flange 20′ is bonded with the material of the fuel port. Since the periphery 23 of the fuel port 16′ is generally annular, the welded connection 26 is provided about the entire periphery 23 (e.g., 360 degrees) of a portion of the fuel port 16′. The welded connection 26 acts as a leakage or permeation barrier between the flange 20 and fuel port 16′, preventing fuel or fuel vapors from passing between the periphery 23 of the fuel port 16′ and the flange 20′.

Although only one fuel port 16′ is shown in FIG. 2, it can be appreciated that other similar ports, with the associated welded connection 26 with the flange 20′ can be provided. Also, welding processes other then laser welding can be employed.

Hence, by employing a conductive fuel port 16′, ESD can be achieved and by providing the welded connection 26 a fuel leakage barrier is provided.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A flange structure for a fuel supply unit of a vehicle, the flange structure comprising:
at least one electrically conductive fuel port having a periphery and first and second ends,
a plastic flange overmolded on at least a portion of the periphery of the fuel port between the first and second ends, the flange being constructed and arranged to be coupled with a fuel tank of a vehicle, and
a welded connection between the fuel port and the plastic flange defining a barrier to prevent fuel or fuel vapor from passing between the periphery of the fuel port and the flange.

2. The flange structure of claim 1, wherein the fuel port is composed of electrically conductive plastic.

3. The flange structure of claim 1, wherein at least a portion of the periphery of the fuel port includes surface features that engage with the overmolded flange.

4. The flange structure of claim 3, wherein the surface features are wave-like features.

5. The flange structure of claim 1, wherein at least the second end of the fuel port is a male end that includes barbs for connecting with tubing.

6. The flange structure of claim 1, wherein the welded connection is a laser welded connection.

7. The flange structure of claim 1, wherein the periphery of the fuel port is generally annular, the welded connection being about the entire annular periphery of a portion of the fuel port.

8. A flange structure for a fuel supply unit of a vehicle, the flange structure comprising:
at least one electrically conductive fuel port having a periphery and first and second ends,
a plastic flange overmolded on at least a portion of the periphery of the fuel port between the first and second ends, the flange being constructed and arranged to be coupled with a fuel tank of a vehicle, and
means for bonding between the fuel port and the plastic flange and defining a barrier to prevent fuel or fuel vapor from passing between the periphery of the fuel port and the flange.

9. The flange structure of claim 8, wherein the means for bonding is a welded connection.

10. The flange structure of claim 9, wherein the welded connection is a laser welded connection.

11. The flange structure of claim 8, wherein at least a portion of the periphery of the fuel port includes surface features that engage with the overmolded flange.

12. The flange structure of claim 11, wherein the surface features are wave-like features.

13. The flange structure of claim 8, wherein at least the second end of the fuel port is a male end that includes barbs for connecting with tubing.

14. The flange structure of claim 8, wherein the periphery of the fuel port is generally annular, the welded connection being about the entire annular periphery of a portion of the fuel port.

15. A method of providing a flange structure for a fuel supply unit of a vehicle, the method including:
providing at least one electrically conductive fuel port having a periphery and first and second ends,
overmolding a plastic flange on at least a portion of the periphery of the fuel port between the first and second ends, and
welding a connection between the fuel port and the plastic flange defining a barrier to prevent fuel or fuel vapor from passing between the periphery of the fuel port and the flange.

16. The method of claim 15, wherein the providing step includes insert molding the fuel port from electrically conductive plastic.

17. The method of claim 15, wherein the welding step includes laser welding the connection.

18. The method of claim 15, wherein the periphery of the fuel port is generally annular, and wherein the welding step includes laser welding the connection to be about the entire annular periphery of a portion of the fuel port.
